(19) United States
(12) Patent Application Publication
(10) Pub. No.: US 2010/0163642 A1
(43) Pub. Date: Jul. 1, 2010

(54) FIXED FLOATING FOUNTAIN

(76) Inventors: RONALD S. DEICHMANN, High Ridge, MO (US); Robert L. Kuykendal, High Ridge, MO (US)

Correspondence Address: CHARLES C. MCCLOSKEY, 763 S. NEW BALLAS ROAD STE. 305, ST. LOUIS, MO, 63141, US

(21) Appl. No.: 12/347,725

(22) Filed: Dec. 31, 2008

(51) Int. Cl. B05B 17/08

(52) U.S. Cl. 239/17

(57) ABSTRACT

A device locates a fountain assembly permanently at a specific desired location while the fountain assembly floats in a confined area, or to fix the fountain assembly at a selected height. A sleeve upon a frame supports fountain equipment as the sleeve moves vertically upon the pier as adjacent water levels change. The invention also provides a method of installing a fountain assembly within a water body where an installer uses an alignment guide and a mechanical means to embed a metallic pier in the bottom of the water body at a precise location. Then the installer places the fountain assembly onto the installed pier as a float provides neutral buoyancy for the assembly. The frame and float generally locate the nozzle of a fountain proximate the surface of the water body with the remainder of the fountain equipment being submerged.

### BACKGROUND OF THE INVENTION

The fixed floating fountain generally relates to ornamental water fountains and more specifically to a fountain that floats vertically and remains located in a fixed horizontal position in a shallow water body without a current, such as a pond or lake.

People have a fascination and attraction to water of many kinds. For centuries, people have built, or used, ponds, or lakes, often as decoration or some times as displays of wealth and authority. The lakes have been in rural residences, estates, and farms, and in urban settings often within parks. Whether commissioned privately or publicly, fountains often have strategic locations in a lake to be seen by admirers and the public. Fountains attract attention. In olden days, fountains had supply plumbing built into a lakebed and extended to an island that supported the nozzle of the fountain. The fountains at the Palace of Versailles have similar construction. In more modern times, fountains have a nozzle mounted on a raft that floats on the lake surface but has a tether to the lakebed or the lake shore. The modern fountains move around on a lake surface generally under action of the wind but restrained by the length of a tether and the surface water level. The floating fountains generally pump their water from the lake in the vicinity of the raft.

### DESCRIPTION OF THE PRIOR ART

The modern floating fountains move farther laterally from their tethers as the lake surface elevation decreases. Lake surfaces drop during periods of drought or other events that reduce the inflow of water to a lake while evaporation continues. At lower lake levels, floating fountains may move closer to the lakeshore and overspray from fountains may enter adjacent structures.

Piers have also been used for decades in water bodies to support structures. A plurality of piers is generally emplaced into a lakebed using powered drivers for hammering into the lakebed or for turning auger flights into the lakebed. Once installed, a structure is built upon the piers and the structure remains at a constant elevation regardless of the water level below the structure. Cofferdams have also been constructed for decades where interlocking piles form a chamber that then has water pumped out. The cofferdam piles seal to each other using an interlocking seam and keep water out while allowing dry work within the dam. However, structures are generally not constructed upon cofferdams.

The present invention overcomes the difficulties of the prior art. The present invention includes a system and method of placing fountain heads, pumps, lighting fixtures, spray rings, controls, motors and animation equipment, fasteners and associated equipment, either directly or through the use of subassemblies, onto piers secured into the bottom of a water body, such as a lake, by rotational torque applied to helical threads upon a pier. The present invention allows fountain equipment to rise and fall with lake surface elevation but not move laterally from its tether, generally a pier.

### SUMMARY OF THE INVENTION

Generally, the present invention provides a device that locates a fountain assembly permanently at a specific location while allowing the fountain assembly to float in a confined area, or alternatively to fix the fountain assembly at a selected height. The invention also provides a method of installing a fountain assembly within a shallow water body. In the method, an installer uses an alignment guide and a mechanical rotational means to embed a metallic pier with a helical tipped point in the bottom of the water body at a precise location. Then the installer places the fountain subassembly onto the installed pier.

There has thus been outlined, rather broadly, the more important features of the invention in order that the detailed description thereof that follows may be better understood and that the present contribution to the art may be better appreciated. The present invention also includes floats, platforms, mechanical equipment, electrical service lines, lighting, and related fountain equipment.

Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a new and improved fixed floating fountain.

Another object is to provide such a fixed floating fountain that floats with a water surface as the water surface fluctuates in elevation.

Another object is to provide such a fixed floating fountain that remains closely above its support, often a pier, as a water surface changes elevation.

Another object is to provide such a fixed floating fountain that has a low cost of manufacturing so the purchasing organizations can readily buy the fixed floating fountain through supply sources.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 illustrates a front view of a prior art pier embedded into the bed of a water body;

FIG. 2 shows a front view of the top of a pier including the present invention and related fountain equipment;

FIG. 3 shows a side view of fountain equipment installed upon a pier including the present invention; and,

FIG. 4 describes a side view of an alternate embodiment of the present invention upon a pier.

The same reference numerals refer to the same parts throughout the various figures.

### DESCRIPTION OF THE PREFERRED EMBODIMENT

The present invention overcomes the prior art limitations and provides a fixed floating fountain that follows the level of water in a lake, pond, or other water body while remaining in the same position relative to the shore of the water body. Ornamental water fountains are often placed in lakes or other shallow bodies of water and anchored in place but allowed to float upon the water in a somewhat confined area. The present invention generally is for usage in still water bodies such as lakes and ponds with lesser application in moving waters such as rivers.

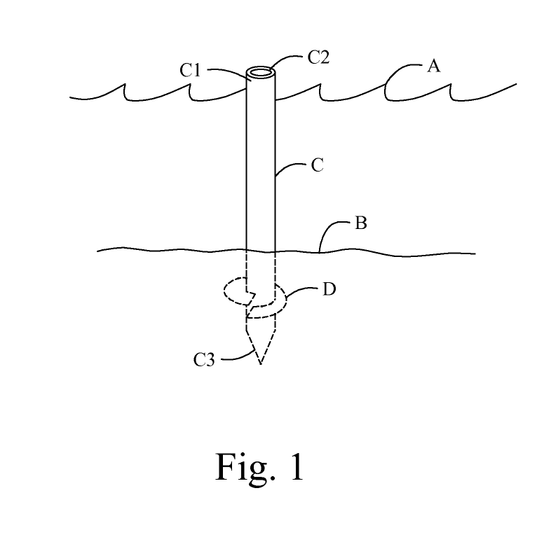

The invention begins with FIG. 1 where a prior art pier C locates within a lake. The pier extends above the lake surface A ready to accept a structure and embeds into the lake bottom B or lakebed, using percussion or a helical shaped plate as at D. The prior art pier can be of wood, metal, or plastic of sufficient rigidity and stiffness to withstand the means of installation, hammering or rotation. The helical plate D allows the pier to function as a large screw where machinery imparts a rotational torque to the top of the pier that turns the entire pier and the helical plate. The rotation of the pier and angle of the plate advance the tip of the pier into the lake bottom for a sufficient distance so friction with adjacent soils holds the pier upright and prevents ripping of the pier from the lakebed. The embedment distance is generally calculated once lake bottom soil conditions and moisture content are known.

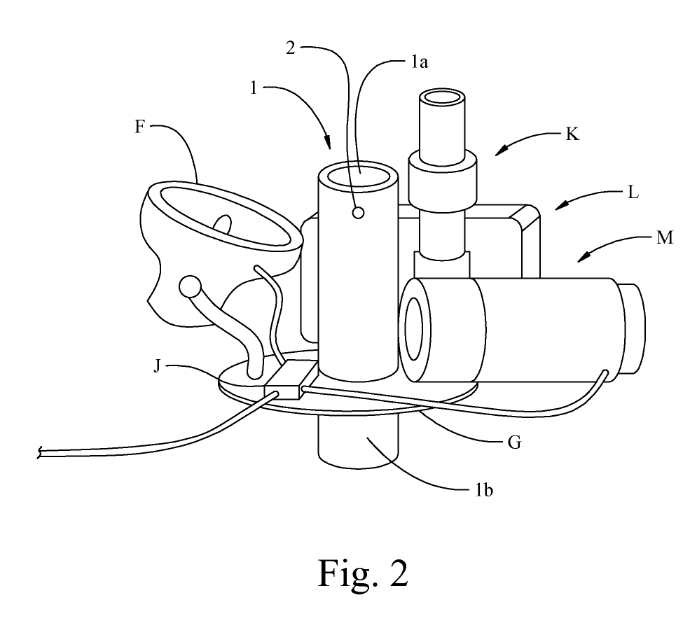

FIG. 2 then shows a fountain assembly that installs upon the pier C using the present invention. The fountain assembly has at least one pump M in fluid communication to at least one nozzle K that is mounted to a frame G. The frame G is generally flat and rigid with a round shape and a central aperture for fitting over the pier. The frame also supports at least one fountain light assembly F and its related electrical controls and supplies as at J. The electrical controls include sensors, logic boards, and timers as is known in the art. The preferred electrical supply is utility service delivered through underwater cabling. Alternatively, the electricity for the fountain can be provided by battery storage, solar cells, wind turbines, wave generators, and like alternate energy sources. The present invention begins upon the interior of the frame G where a sleeve 1 extends upwardly from the frame. The sleeve is generally a hollow cylinder with an inside diameter greater than the width of the pier. For a tight installation with limited lateral movement of the fountain assembly, the sleeve inside diameter is generally that of the outside width of the pier. For an installation that allows some lateral movement of the fountain assembly, the sleeve has a diameter noticeably greater than the width of the pier. The sleeve has two opposite and open ends 1a, 1b and a rigid sidewall. In an alternate embodiment, the sleeve includes an aperture 2 that aligns with an aperture placed into the top of the pier. Outwardly from the sleeve, the frame has a float L attached. The float displaces sufficient freshwater to compensate for the weight of the fountain assembly. Generally the float geometry and location upon the frame allow just the nozzle to barely breach the lake surface A. In an alternate embodiment, the float has a proportional geometry to accommodate the density of salt water.

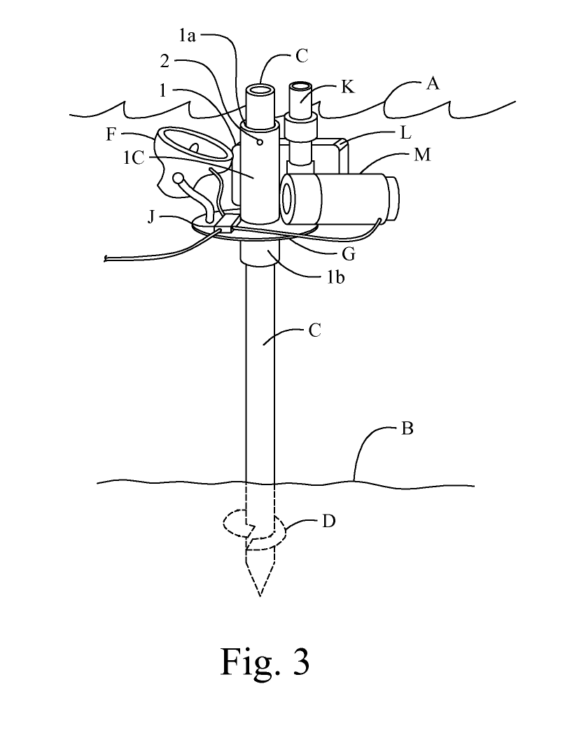

Stepping back from FIG. 2, FIG. 3 shows the fountain assembly installed upon a full height pier C. The pier is embedded into the lake bottom B using the helical flight D. The fountain assembly has various components locating upon a frame G. The frame also has a centrally located sleeve 1 that is generally perpendicular to the plane of the frame. The sleeve has a lower end, as at 1b, positioned below the frame and an opposite or upper end, as at 1a, locating above the frame and fountain components. Proximate the upper end, the sleeve has an aperture 2. The aperture admits a pin, not shown, that engages a cooperating opening on the pier. When the aperture aligns with the opening, an engaged pin holds the sleeve 1 and the attached fountain assembly at a fixed elevation upon the pier.

When the pin is removed, the fountain assembly may move vertically upon the pier as the frame moves up and down with the lake surface A. To locate the fountain nozzle at a suitable elevation from the lake surface, the frame has a float L that displaces a sufficient volume of water to accommodate the weight of the fountain assembly. Generally the float makes the fountain assembly attain neutral buoyancy and just the nozzle breaks the lake surface. As shown in FIG. 3, the remainder of the fountain assembly remains submerged and out of sight from lake users.

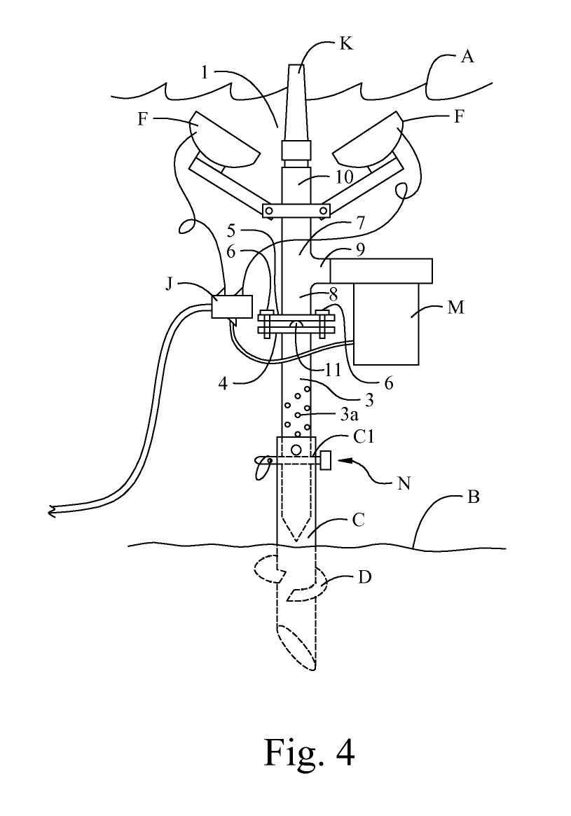

In locations where water level fluctuates very little or the appearance of the fountain assembly above the water can be accepted by lake users, FIG. 4 shows an alternate embodiment of the invention. As before, a hollow pier C embeds into the lake bottom B using a helical flight D though a hammer embedded pier is also foreseen. The pier has an opening C1, here that extends through the width of the pier. The opening C1 receives a pin N inserted therein. The pin also passes through a lower stem 3, generally elongated and cylindrical. The lower stem has two opposite ends, one end being a tip, and a plurality of holes 3a in an array proximate the tip. The holes are located about the perimeter of the lower stem and extend partially along the length of the lower stem. The array of holes allows for adjusting the portion of the lower stem that extends outwardly and above the pier. The lower stem has a lesser width than the inside diameter of the pier. Opposite the tip, the lower stem has a lower plate 4 generally perpendicular to the length of the lower stem. The lower plate is also wider than the lower stem. The lower plate has a boss 11 generally centered thereon and extending away from the tip and the pier. The boss has a generally round shape.

Above the lower stem, the alternate embodiment has an upper stem 7, generally elongated and cylindrical. The upper stem has two opposite ends, one end, as at 8, joins to an upper plate 5 and the other end, as at 10, provides for the connection of the nozzle. The upper plate has a similar shape as the lower plate and is perpendicular to the length of the upper stem and the lower stem. The upper plate and the lower plate each have at least three bolts 6 extending through both plates. Each bolt passes through a threaded hole upon the lower plate. The upper plate rests upon the boss 11 and attains a level or other suitable orientation using the bolts. Adjusting the bolts and moving the upper plate towards or away from the lower plate alters the angle of the upper stem relative to the lower stem. In most installations, the upper stem is generally coaxial with the lower stem. However, where the lower stem embeds into the lake bottom B at an angle, the action of the bolts 6 allows the upper stem to be aimed perpendicular to the lake surface. Where the fountain assembly creates a tall fountain, an upper stem perpendicular to the lake surface becomes critical to minimize the fountain spray reaching the shore. In other situations, an angle for a fountain may be desirable and the bolts in combination with the upper plate and the lower plate permit angled installation of the upper stem 7.

Proximate the end 8 of the upper stem, the upper stem has a generally T shape commonly called a tee. The tee extends outwardly, as at 9, and connects to a pump M. The tee and the upper stem above the end 8 are generally hollow to allow for transmission of water there through. The pump draws water from the water body and releases pressurized water into the upper stem through the tee. Electrical controls and other hardware as at J operate the fountain components. The tee carries water upwardly through the upper stem into the other end, as at 10. That end 10 has the appropriate fittings to connect a nozzle K. The upper stem delivers pumped water directly into the nozzle to create a fountain. The upper stem also provides a convenient mounting site for lighting F. The armatures of the lighting bolt upon the exterior of the upper stem and space the lights outwardly from the nozzle. The lighting can be aimed upwardly to illuminate the fountain as desired.

From the aforementioned description, a fixed floating fountain has been described. The fixed floating fountain is uniquely capable of restraining a fountain laterally upon a pier while allowing the fountain to move vertical upon the pier as water level changes in the water body surrounding the fountain. The fixed floating fountain is preferably made from galvanized steel and related water proof materials. The fixed floating fountain and its various components may be manufactured from many materials, including but not limited to, polymers, polyvinyl chloride, high density polyethylene, polypropylene, nylon, steel, ferrous and non-ferrous metals, their alloys, canvas, rugged textiles, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A system locating a fountain in a water body that has a surface, the fountain capable of changing elevation as the water body changes elevation while the fountain remains in place laterally, said system has a pier with a top proximate the surface of the water body and an opposite tip for embedment into the bottom of the water body, a power source, a pump in communication with the power source, a nozzle upon the pump wherein the nozzle creates the fountain, at least one light in communication with the power source and aimed at the fountain, and a frame supporting the power source, the pump, and the light, wherein the improvement comprises:
a hollow sleeve joining perpendicular to the frame;
a float locating upon said frame wherein the displacement of said float is approximately the combined weight of the pump, the nozzle, the frame, the power source, and the at least one light; and,
said float and said hollow sleeve cooperating wherein the nozzle breaches the surface of the water body.

2. The fountain locating system of claim 1 further comprising:
a hole locating in the top of said pier; and,
said sleeve having an aperture therein generally locating opposite the frame.

3. The fountain locating system of claim 1 further comprising:
a pin generally engaging said aperture of said sleeve and said hole of said pier being in mutual alignment thus fixing said sleeve to the pier at a predetermined elevation.

4. A system locating a fountain in a water body that has a surface, the system capable of changing elevation as the water body changes elevation while the fountain remains in place laterally, said system locating upon a pier, said system comprising:
a frame adapted to support fountain equipment thereon, said frame slidingly engaging the pier;
a hollow sleeve centered upon said frame and joining perpendicular to the frame;
a float locating upon said frame wherein the displacement of said float is approximately the weight of fountain equipment locating upon said frame; and,
said float and said hollow sleeve cooperating wherein the fountain equipment locates slightly below the surface of the water body.

5. The fountain locating system of claim 4 further comprising:
a hole adapting to locate in the pier; and,
said sleeve having an aperture therein generally locating opposite the frame, said aperture capable of aligning with said hole.

6. The fountain locating system of claim 5 further comprising:
a pin generally engaging said aperture of said sleeve and said hole of the pier thus preventing said frame from sliding axially upon the pier.

7. A system locating a fountain in a water body that has a surface, the fountain remaining in place laterally and vertically, said system has a hollow pier with a top beneath the surface of the water body and an opposite tip embedded into the bottom of the water body, a power source, a pump in communication with the power source, a nozzle in communication with the pump wherein the nozzle creates the fountain, and at least one light in communication with the power source and aimed at the fountain, said system comprising:
a lower stem, generally elongated, having a tip and an opposite lower plate, said tip inserting into the pier and said lower stem mechanically connecting to the pier;
said lower plate locating perpendicular to said lower stem and having a width greater than the width of said lower stem, said lower plate having a centered boss thereon extending opposite said tip, said boss having a radius less than the width of said lower stem;
an upper stem, generally coaxial with said lower stem having an upper plate and an opposite opening generally opposite said pier, said upper stem being generally hollow and transmitting water from the pump therethrough to the nozzle;
said upper plate locating perpendicular to said upper stem and having a width greater than the width of said upper stem, said upper plate having a planar surface opposite said opening and abutting said boss of said lower plate; and,
at least three elongated threaded members extending through said upper plate to said lower plate, said bolts allowing for pivoting of said upper plate upon said boss wherein said upper stem is aimed to direct the fountain from the nozzle.

8. The fountain locating system of claim 7 further comprising:
said lower stem having a plurality of apertures therethrough proximate said tip;
the pier adapting to have diametrically aligned holes therethrough; and,
a pin generally engaging said holes of the pier and passing through one of said apertures in said lower stem thus fixing said system at a predetermined elevation.

9. The fountain locating system of claim 7 further comprising:
said upper stem having an integral branch proximate said lower plate and perpendicular to said upper stem, said branch being hollow and communicating water from the pump into said upper stem.

10. The fountain locating system of claim 9 further comprising:
said upper stem beneath said branch proximate said upper plate being of solid construction.

11. The fountain locating system of claim 9 further comprising:
said branch having a length wherein the pump connecting to said branch locates outwardly of said upper plate and said lower plate.
